(19) United States
(12) Patent Application Publication
(10) Pub. No.: US 2004/0146757 A1
(43) Pub. Date: Jul. 29, 2004

(54) Fuel cell apparatus with a starting device

(76) Inventors: Ulrich Gottwick, Stuttgart (DE); Rainer Saliger, Freiberg (DE); Jan-Michael Graehn, Stuttgart (DE)

Correspondence Address: STRIKER, STRIKER & STENBY, 103 East Neck Road, Huntington, NY, 11743, US

(21) Appl. No.: 10/738,063

(22) Filed: Dec. 17, 2003

(30) Foreign Application Priority Data
Dec. 17, 2002 (DE) 102 58 865.1

(51) Int. Cl. H01M 8/04; B60L 11/18

(52) U.S. Cl. 429/13; 429/22; 180/65.3

(57) ABSTRACT

A fuel cell apparatus has a fuel cell unit, a first electronic control unit for producing an electrical control signal, at least one starting device for starting the first electronic control unit and formed as a second electronic control unit for producing an electrical input signal of the first electronic control unit and at least one further electrical signal as a starting signal of the second electronic control unit, the second electronic control unit having an electronic evaluating unit formed so that the two independent electrical starting signals are automatically connected with one another with the electronic evaluating unit of the second electronic control unit.

### BACKGROUND OF THE INVENTION

The present invention relates to a fuel cell apparatus with a fuel cell unit, a first electronic control unit, and a starting device.

Conventional fuel cell units have for example a fuel cell or a fuel cell stack which include a semi permeable membrane, wherein the operational temperature must be sufficient to provide a required ion conductivity through the electrolyte. Moreover, such fuel cell systems have different catalytically active components, such as reformers, gas purification stages, etc. with which the operational temperature must lie over the so-called light-off temperature of the catalyst, to allow desired reactions in full degree.

Since the operation, in particular of the above mentioned components of the fuel cell apparatus is closely connected with reaching of the hereby predetermined operational temperature, the known fuel cell systems have the difficulty to guarantee the required power in acceptable short time after the desired start. This is especially important for mobile applications or vehicles. The electrical energy produced by the fuel cell unit can be used in electrical vehicles for current supply of electric motors or in hybrid vehicles as an auxiliary drive by means of an electric motor and/or as a so-called auxiliary power unit (APU) for power supply of additional electrical aggregates of the vehicle.

The fuel cells or the reformer in general must be supplied in the starting phase with heat energy, by means of an electrical heater or the like, to guarantee the required operational temperature for complete conversion of the fuel with air oxygen or for current supply. In some cases, depending on the selected reforming processes, additional water is required, which frequently is heated or evaporated for this purpose.

Conventional fuel cell systems are started with a mechanical ignition lock or switch at a time point when the start is desired by the user or driver. An electrical control unit produces for this purpose the electrical starting signal for the fuel cell apparatus or individual components. This means that in general with the mechanical switch the current supply of the electronic control unit is performed and thereby the heating of the fuel cell unit or catalytically active components starts.

Existing heating or starting times for the fuel cell system are provided for example in available fuel cells such as for example the so-called PEM in a region within several tenths seconds, and in so-called SOFC in a region of 20 minutes. In many applications, in particular in motor vehicles it does not correspond to the modern requirements of comfort.

Moreover, a “prompting system” is known, in which a separate command is provided by the driver for starting the fuel cell system, spatially and/or timely uncoupled from actuation of the mechanical starter (as disclosed in the European patent document EP 1 211 120 A1). Here an external or an internal electrical signal is used, which is generated for example by a remote operation, a garage light or a door contact. The disadvantage of this approach is that the fuel cell system is started with a single signal of the starting process, which in the case of disturbances of the signal generator can cause turning on of the garage light or opening of the driver door without the driver, etc., and can lead to heating process and thereby energy consumption of the fuel cell apparatus. Thereby in some cases the electrical energy storage can empty and a starting of the system can no longer be guaranteed.

### SUMMARY OF THE INVENTION

Accordingly, it is an object of the present invention to provide a fuel cell apparatus with a starting device, which is a further improvement of the existing fuel cell apparatus.

More particularly, it is an object of the present invention to provide a fuel cell apparatus with a starting device, which is more tolerant to disturbances and/or more flexible to different everyday conditions than in the prior art.

In keeping with these objects and with others which will become apparent hereinafter, one feature of the present invention resides, briefly stated, in a fuel cell apparatus of the above mentioned general type, which has a fuel cell unit; a first electronic control unit for producing an electrical control signal; at least one starting device for starting said first electronic control unit and formed as a second electronic control unit for producing an electrical input signal of said first electronic control unit and at least one further electrical signal as a starting signal of said second electronic control unit, said second electronic control unit having an electronic evaluating unit formed so that said two independent electrical starting signals are automatically connected by one another with said electronic evaluating unit of said second electronic control unit.

In accordance with the present invention, in the inventive fuel cell apparatus at least two independent electrical signals are automatically connected or linked with one another by an electronic evaluating unit of the second electronic control unit, or the second electronic control unit includes at least one evaluating unit for evaluating and/or logical connection of several starting signals with one another. For example, several electrical signals which are generated independently from one another can be combined preferably by logic, in particular programmable combination or linking, which provides a fast use of the fuel cell apparatus or a corresponding vehicle with high probability. For this purpose corresponding associations and relations of different inventive starting signals or starting commands can be provided in the testing or evaluating unit. For example, this can be realized in particular by programmable state graphs, characteristic fields, or fuzzy logic or the like.

In accordance with the present invention, available electrical signals with a function which is substantially independent from the fuel cell apparatus can be additionally used as starting signals. This means that the electrical signals in accordance with the present invention perform at least two functions, at least one function which is relevant or decisive with respect to the fuel cell apparatus, and at least one function which is not relevant and not important with respect to the fuel cell apparatus. For example, at the following signal generators or starters can be used in accordance with the present invention: Signals, door contacts, seat contacts, unblocking of the drive of lock, unlocking of the door, brake light switch or brake pedal actuation, ignition lock position, starter, additional charging of the battery which is emptied by leakage current and/or consumer of the vehicle, or a corresponding voltage level is too low, or a corresponding signal from the electrical system management, time switch clock, in particular a remotely programmable time switch clock, a radio actuation, etc. In accordance with the present invention two or more of these or other starting signals are connected with one another or evaluated in an advantageous manner.

By means of the available electrical signals which are produced and evaluated independently from the fuel cell apparatus, an advantageous warming phase or heating period before the start of the fuel cell apparatus or before the actuation of the start element by the user or driver can be realized, preferably in dependence on whether the start is provided however in a foreseeable time very reliably. It is possible to provide a continuous time uncoupling of the warming phase of the fuel cell apparatus from the time point of the actuation of the start/ignition element or the start with of the user in accordance with the present invention.

In particular by the connecting or testing of several starting signals, technical disturbances of the signal generator or different every day requirements, in which the vehicle is not set in operation, can be recognized and unnecessary warming up or imitating of the starting phase of the fuel cell apparatus can be efficiently prevented. Hereby the efficiency or the everyday applicability of the system is significantly increased when compared with the prior art. It is possible that on the other hand a starting signal is produced without a second following one. This involves a situation in which the driver in reality does not want to move off, for example the vehicle door is open in the garage, but the drive off lock is not deactivated. On the other hand, a start signal in some cases can be produced by mistake, for example the brake gas switch or seat contact generator starting signal without previously opening the door.

The electrical control signal of the fuel cell apparatus can be formed for example for controlling or acting with electrical energy and/or a heating fuel of a heating unit for warming up at least the fuel cell unit and/or a catalytically active reactor or convertor unit to an operational temperature. For example the heating unit can be formed as an electrical heating unit and/or a catalytic burner. By means of the catalytic burner, hydrogen containing fuel or the like stored in the storage is converted in particular with air oxygen catalytically to release heat. In some cases this catalytic burner additionally has an electrical heating unit for preheating.

Furthermore, there is a possibility to start the fuel cell system with the supply of heat. For this purpose for example a fuel cell system operates with lower temperatures, for example to −20° C. With the heat produced thereby, the initially relative low power is increased in approximately 10 seconds to the nominal power. With the invention, this time period is substantially bridged in an advantageous manner.

The catalytically active conversion unit, in particular a reformer, is formed for chemical reaction of at least one fluid, for example a hydrocarbon-containing fuel, such as gasoline, diesel, natural gas, methanol or the like. Furthermore, the catalytically active conversion unit can be formed as a so-called shift-end/or oxidation stage for purification of a hydrogen containing reformate, wherein first of all carbon monoxide fraction of the reformate is converted for example to carbon dioxide or methane. This prevents in particular a poisoning of convention PEM fuel cells.

Advantageously, the second electronic control unit can be formed as an electronic switching device for turning on and/or turning off of the energy supply of the first electronic control unit. For example the second electronic control unit is formed so that it can receive or read these approximately permanent electrical signals. This means that the second control unit is supplied with current permanently and in some cases in a “sleeping mode” with reduced functionality and reduced energy consumption which changes with receiving of the electrical signal in accordance with the present invention to an “awaken mode” with full functionality and an increased energy consumption.

The second electronic control unit is preferably formed so that it has a relatively low energy pickup, in particular when compared with the first control unit, but it can receive the inventive electrical signals by means of an advantageous receiver. For example, with receiving of an electrical signal in accordance with the present invention, the second electronic control unit turns on the first electronic control unit. This means that the first electronic control unit is supplied with current and for example sends the electrical control signal to the fuel cell apparatus or the heating unit, catalytically acting conversion unit, or the like.

Ordinarily, by permanent reading of electrical signals, which can be connected with a fast use of the fuel cell apparatus of the vehicle, with the second electronic control unit or prompting unit the first electronic control unit can be supplied with electrical energy, so that the heating process of corresponding components can be started or released.

Preferably, the starting signal is formed as a wireless signal of an electronic transmitter, a time signal of an electronic time function element, a switching signal of an electromechanical switching member, a sensing signal of an electronic sensor, and/or a monitoring signal of an electrical storage. For example, the transmitter for producing the inventive wireless signal is a remote device, a telecommunication system, etc. In general, the wireless signal is an electromagnetic wireless or radio signals, in particular in the range of technical high frequencies, microwaves, infrared radiation, radar radiation and the like.

In accordance with a preferable embodiment of the invention, as the electric time function element, an available board clock in a vehicle is utilized, so that in an advantageous manner an approximately automatic start of the fuel cell apparatus at a predetermined time point can be performed. This is especially advantageous in special application cases when the fuel cell apparatus must be ready for start for example frequently at predetermined time points, such as for example in a vehicle which is required during working days to travel to work and back. It is recommended to use a house clock of the user and/or a satellite-supported clock as a time function element in accordance with the present invention. The electromechanical switching member or the electrical sensor can be formed as a door contact, a seat contact, an inner space sensor, a brake light switch or similar electromechanical switches or electromechanical sensors for example of a vehicle.

Preferably, the second electronic control unit has at least one learning algorithm for adaptation to repeated operational conditions. For example the second electronic control unit recognizes the repeated operational conditions, stores them and learns from them. This means that by means of the inventive learning algorithm it is possible to begin the start of the fuel cell apparatus at a time point which is before the use of the fuel cell apparatus of the vehicle, so that no waiting time for the user or the driver in accordance with the present invention occurs. This is especially advantages for regular travels, for example to a workplace and back.

Advantageously, the evaluating unit has at least one time function element. Thereby it is for example possible that after the reception of the starting signal and after elapsing of a predetermined time period, by means of the time function element of the invention it is detectable that the availability over non availability of a further starting signal can be used so that the starting process introduced by the first starting signal is interrupted because of the second starting signal or because of non availability of the second starting signal. This is especially advantageous in such applications when for example a door of a vehicle is open, whereby a first starting signal is produced, and the driver does not want to start the vehicle, so that for example an actuation of the brake contact, ignition lock or the like is interrupted, and this leads to interruption of the warming up phase. Thereby for example electrical and thermal losses of a fuel cell system which is initialized but not required, can be advantageously prevented.

An electrical signal for monitoring of electrical storages from a board system control device of the vehicle, etc. can be for example read in the second electronic unit, and utilized as a starting signal for starting the fuel cell apparatus in accordance with the present invention. For example, for this purpose the so called state of charge or state of health signal can be utilized. This is advantageous especially for hybrid APU-vehicle applications.

In general, the fuel cell apparatus or its heating phase can be started or initiated with reaching of a predetermined threshold value or with digital signals during change of the state of the starting signal in accordance with the present invention. For example a post charging of electrical storage by means of the inventive fuel cell apparatus can be performed with the receiving of corresponding electrical signals about the charging state of the storage. Thereby, in advantageous manner, a relatively higher charge condition of the electrical storage is guaranteed so that for example electrical energy sufficient for other starting processes can be made available for the system, for example for heating a catalyst of a combustion engine by means of an accumulator or battery in systems with so-called APU or for supply of the starter battery in case of non sufficient charge during the traveling cycle, for heating or air conditioning in the first seconds after the start of traveling, etc.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawings is a view illustrating a fuel cell apparatus with a starting device of the present invention.

### DESCRIPTION OF THE PREFERRED EMBODIMENTS

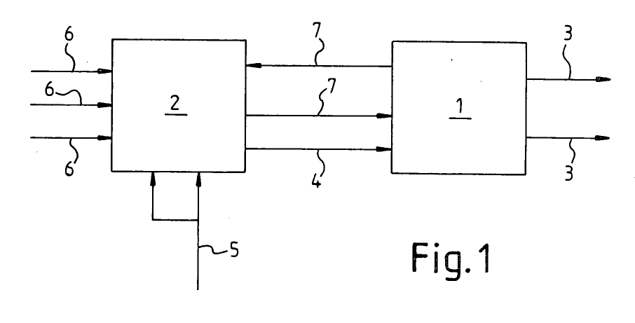

An embodiment of the present invention is illustrated in the drawings. FIG. 1 is a view showing a block diagram of a circuit connection of two control units 1 and 2 in accordance with the present invention. The fuel cells-control unit 1 produces control signals for not shown components of a fuel cell apparatus. For example, the components include one or several heating devices for heating a fuel cell unit, a convertor, purification stages or the like, or also only gas dosing components for supply of the fuel cells. The control unit 1 produces or sends the control signals 3 based on an initiation through the electronic prompting system 2.

The prompting system 2 is supplied with current continuously or permanently, or in other words it has a permanent electrical energy receiver. Therefore, prompting signals 6 which are detected or read at an arbitrary time point generate the current supply 4 of the control unit 1 either directly or through the board electrical system topology 4′, 4″ and supply the control signals 3. Moreover, the prompting system 2 exchanges further electrical signals 7 with the control unit 1 for communication.

Basically, a failure of a further starting signal which is subsequent to a first starting signal over a certain, predetermined time period is utilized so that the prompting signal is not set or retrieved and the system is again turned off. The corresponding time period in advantageous manner depends on the first starting signal. For example, after the unlocking of the drive off lock within a time period of approximately 5 minutes, a change of the signal of the door contact can be provided.

Furthermore, in accordance with a variant of the invention the time period depends on an ambient temperature or a corresponding sensor or can be adjusted to it. Thereby, in case of low temperatures the system when a further starting signal does not approach can be designed more tolerant that at relatively warm ambient temperatures.

It is possible that when a further signal does not appear within a predetermined time period, an individual start signal alone is sufficient to start the system, since it deals with a condition, in which the vehicle was not completely shut off, for example the door was not locked or was left open, etc. Basically, the actuation of the mechanical starter leads to starting or stopping of the system.

It will be understood that each of the elements described above, or two or more together, may also find a useful application in other types of constructions differing from the types described above.

While the invention has been illustrated and described as embodied in a fuel cell apparatus with a starting device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fuel cell apparatus, comprising a fuel cell unit; a first electronic control unit for producing an electrical control signal; at least one starting device for starting said first electronic control unit and formed as a second electronic control unit for producing an electrical input signal of said first electronic control unit and at least one further electrical signal as a starting signal of said second electronic control unit, said second electronic control unit having an electronic evaluating unit formed so that said two independent electrical starting signals are automatically connected with one another by said electronic evaluating unit of said second electronic control unit.

2. A fuel cell apparatus as defined in claim 1; and further comprising an energy supply for said first electronic control unit, said second electronic control unit being formed as an electronic switching device for turning on and turning off of said energy supply.

3. A fuel cell apparatus as defined in claim 1; and further comprising an electrical transmitter operating so that said starting signal is formed as a wireless signal of said electrical transmitter.

4. A fuel cell apparatus as defined in claim 1; and further comprising an electrical time function element formed so that said starting signal is formed as a time signal of said electrical time transducer.

5. A fuel cell apparatus as defined in claim 1; and further comprising an electrico-mechanical switching member formed so that said starting signal is formed as a switching signal of said electrico-mechanical switching member.

6. A fuel cell apparatus as defined in claim 5; and further comprising an electrical sensor formed so that said electrical signal is formed as a sensor signal of said electrical sensor.

7. A fuel cell apparatus as defined in claim 1; and further comprising electrical storage formed so that said starting signal is formed as a monitoring signal of said electrical storage.

8. A fuel cell apparatus as defined in claim 1, wherein said evaluating unit has an element selected from the group consisting of a time function element and a counter.

9. A fuel cell apparatus as defined in claim 1, wherein said second electronic control unit includes at least one learning algorithm adapted to repeated operational conditions.

10. A vehicle, comprising a vehicle part; and a fuel cell apparatus, said fuel cell apparatus including a fuel cell unit; a first electronic control unit for producing an electrical control signal, at least one starting device for starting said first electric control unit and formed as a second electronic control unit for producing an electrical input signal of said first electronic control unit and at least one further electrical signal as a starting signal of said second electronic control unit, said second electronic control unit having an electronic evaluating unit formed so that said two independent electrical starting signals are automatically connected with one another with said electronic evaluating unit of said second electronic control unit.

11. A vehicle as defined in claim 10; and further comprising an energy supply for said first electronic control unit, said second electronic control unit being formed as an electronic switching device for turning on and turning off of said energy supply.

12. A vehicle as defined in claim 10; and further comprising an electrical transmitter operating so that said starting signal is formed as a wireless signal of said electrical transmitter.

13. A vehicle as defined in claim 10; and further comprising an electrical time function element formed so that said starting signal is formed as a time signal of said electrical time transducer.

14. A vehicle as defined in claim 10; and further comprising an electrico-mechanical switching member formed so that said starting signal is formed as a switching signal and an electrico-mechanical switching member.

15. A vehicle as defined in claim 14; and further comprising an electrical sensor formed so that said electrical signal is formed as a sensor signal of said electrical sensor.

16. A vehicle as defined in claim 10; and further comprising electrical storage formed so that said starting signal is formed as a monitoring signal of said electrical storage.

17. A vehicle as defined in claim 10, wherein said evaluating unit has an element selected from the group consisting of a time function element and a counter.

18. A vehicle as defined in claim 10, wherein said second electronic control unit includes at least one learning algorithm adapted to repeated operational conditions.

19. A method of starting of a fuel cell apparatus, comprising the steps of providing in the fuel cell apparatus a fuel cell unit producing an electrical control signal by a first electronic control unit; starting the first control unit by a starting device; and connecting at least two independent electrical starting signals automatically with an evaluation unit of a second electronic control unit.

20. A method as defined in claim 19; and further comprising forming, said second electronic control unit as an electronic switching device for turning on and turning off of said energy supply.

21. A method as defined in claim 19; and further comprising forming said starting signal as a wireless signal of a electrical transmitter.

22. A method as defined in claim 19; and further comprising forming said starting signal is formed as a time signal of an electrical time transducer.

23. A method as defined in claim 19; and further comprising forming said starting signal is formed as a switching signal of an electrical mechanical switching member.

24. A method as defined in claim 23; and further comprising forming said electrical signal as a sensor signal of an electrical sensor.

25. A method as defined in claim 19; and further comprising forming said starting signal as a monitoring signal of an electrical storage.

26. A method as defined in claim 19; and further comprising providing in said evaluating unit an element selected from the group consisting of a time function element and a counter.

27. A method as defined in claim 19; and further comprising providing in said second electronic control unit at least one learning algorithm adapted to repeated operational conditions.
